(19) United States
(12) Patent Application Publication
(10) Pub. No.: US 2012/0045193 A1
(43) Pub. Date: Feb. 23, 2012

(54) CAMERA SYSTEM WIRELESS ACTIVATION METHODS AND APPARATUS

(76) Inventor: KEVIN J. KING, VANCOUVER, WA (US)

(21) Appl. No.: 13/211,986

(22) Filed: Aug. 17, 2011

Related U.S. Application Data
(60) Provisional application No. 61/374,600, filed on Aug. 17, 2010.

(51) Int. Cl. G03B 15/03

(52) U.S. Cl. 396/56

(57) ABSTRACT

An operation of a non-wireless photographic device, such as light emission from a non-wireless flash, may be synchronized with a selected photographic operation of a wireless camera system, such as image acquisition by a wireless-enabled camera of the system, by receiving a wireless signal transmitted by a wireless camera system device, identifying the signal as preceding the selected operation by a predetermined time interval, and transmitting a signal perceptible to the non-wireless photographic device according to timing calculated so that the responsive operation thereof is synchronized with performance of the selected operation. A wireless activation device for use with the non-wireless photographic device includes a receiving component to receive the wireless signal, a transmitting component to transmit an activation signal perceptible to the non-wireless flash, and circuitry to calculate appropriate timing to transmit the activation signal so activation of the non-wireless device is synchronized with performance of the selected operation.

### RELATED APPLICATION

This application claims the benefit of U.S. Provisional Application No. 61/374,600, filed Aug. 17, 2010, the entire disclosure of which is incorporated herein by reference for all purposes.

### TECHNICAL FIELD

This disclosure relates to flash control in camera systems, and in particular to methods and apparatus for managing flash operations of a non-wireless photographic device with a wireless camera system.

### BACKGROUND

It has been long recognized that communication methods other than by means of directly wired connections have utility and offer advantages in many settings. In a camera system, for example, optical communication, usually in the form of pulses of IR or visible light, enable photographic devices of the camera system to communicate and synchronize operation, without the use of cables or other means of directly connecting the devices to each other. In a standard example, a camera may instruct a remote flash unit to emit light for a pre-flash operation and/or during image acquisition by the camera, by means of operational commands encoded in sequences of optical pulses emitted by the camera and received by the flash unit.

Although it has become conventional for photographic devices to employ optical communication, this approach has limitations, however, such as in shooting conditions in which the ambient lighting, reflective surfaces, weather conditions, and so forth, may interfere with reliable receipt of pulsed optical data. As such, wireless communication systems, i.e. communication systems using radio waves, have been developed for use with conventional camera systems that employ optical means of communication. For example, methods, systems, and devices employing wireless communication for conventional camera systems, such as to establish, facilitate, and maintain wireless communication among various photographic devices of a camera system, to prepare and activate flash units by radio, and so forth, are disclosed in Applicant's co-pending U.S. Patent Application Pub. Nos. US2009012975, US20100008658, US20100124412, US20100158494, and US20100209089, the complete disclosures of which are hereby incorporated by reference. One or more of the aforementioned publications disclose various examples of external wireless communication devices that may be used to retrofit conventional (i.e. non-wireless) photographic devices with wireless functionality.

Recently, photographic equipment has been developed that integrates wireless functionality into photographic devices. The term “wireless-enabled” is used herein to refer to a photographic device, such as a camera, a flash unit, a light metering device, and so forth, that incorporates wireless reception and/or transmission means (and to distinguish, the term “non-wireless,” as used herein, refers to photographic devices that do not incorporate wireless functionality). For example, U.S. Patent Application Pub. No. 20100202767 of Shirakawa discloses a wireless camera system that includes a camera and a flash unit both having built-in wireless capability. In the Shirakawa camera system, the wireless-enabled camera wirelessly transmits a sequence of emitting command packets to the wireless-enabled flash unit, each of which include timing information for a subsequent operation of the camera that will take place at a predetermined time. The timing information in each emitting command packet is different depending on its place in the sequence. Once any of the command packets are received by the wireless-enabled flash unit, circuitry in the flash unit reads the timing information and carries out an emitting operation that is synchronized with the camera operation.

A substantial drawback to the use of wireless-enabled photographic equipment is that many existing photographic devices are non-wireless, and thus may not be compatible with wireless-enabled photographic devices, such as those disclosed in Shirakawa.

### SUMMARY

The methods and apparatus disclosed herein may facilitate synchronization of an operation by a non-wireless photographic device, such as the emission of light by a non-wireless flash device, with that of an operation by a wireless-enabled photographic device, such as an image acquisition operation by a wireless-enabled camera, and/or may otherwise integrate a non-wireless photographic device into a wireless camera system that includes one or more wireless-enabled photographic devices.

In one illustrative method in accordance with the present disclosure, emission of light from a non-wireless flash device may be synchronized with the performance of a selected photographic operation (such as a camera operation, for example, a pre-flash operation, image acquisition, and so forth, or an operation by another photographic device) by a wireless-enabled photographic device that is part of a wireless camera system. Such a method may include receiving a signal wirelessly transmitted by a photographic device (such as a wireless-enabled camera) of the wireless camera system, identifying the received signal as one that characteristically precedes the performance of the selected photographic operation by a predetermined time interval, and determining, from the identified signal, the predetermined time interval. The method may then include transmitting an emission synchronization signal perceptible to the non-wireless flash device so that the responsive emission of light therefrom is synchronized with performance of the selected photographic operation. Depending upon the setup of the wireless camera system, the wireless-enabled photographic device that transmits the received signal may be the same photographic device that performs the selected photographic operation, for example in a wireless camera system in which a wireless-enabled camera transmits flash instructions to wireless-enabled flash devices of the system to synchronize flash operations with various operations of the camera.

In such a method, the identified signal may be a flash instruction such as an emission instruction signal, and further may be one of a sequence of emission instruction signals wirelessly transmitted by the photographic device, each of which may contain different timing information for the performance of a selected photographic operation, depending on its place in the sequence. Accordingly, in such a method, the predetermined time may be determined from the timing information in the identified signal; this method may optionally include subsequently ignoring other emission instruction signals in the sequence. In a variant of such a method, the predetermined time interval may instead be determined using an observed time interval from a prior operation of the wireless camera system, such as one in which a prior iteration of the identified signal preceded the subsequent performance of the selected photographic operation.

Optionally, the identified signal may include information such as an emission output level, in which case transmitting the emission synchronization signal may include transmitting emission output level information corresponding to or otherwise based on the emission output level in the identified signal.

The illustrative method optionally may be interactive, such as by further including a step of wirelessly transmitting a signal back to the photographic device as if it was sent from the non-wireless flash device, and/or by otherwise establishing a communication link with the photographic device such that the photographic device thereafter wirelessly communicates with the non-wireless flash device as if it was another wireless-enabled photographic device of the wireless camera system, such as a wireless-enabled flash device.

The illustrative method may further include transmitting the emission synchronization signal to the non-wireless flash device in any manner suitable to the non-wireless flash device, such as by sending the emission synchronization signal optically, via an electrical connection, and so forth. Such a method may thus include initiating the transmission at a time sufficiently in advance of the performance of the photographic operation so as to complete transmission and allow the non-wireless flash device any necessary time to emit light synchronized with performance of the photographic operation.

In another illustrative method in accordance with the present disclosure, a non-wireless photographic device (such as a non-wireless flash device, or otherwise) may be integrated into a wireless camera system in which a master device of the wireless camera system (such as a wireless-enabled camera, a remote control device, and so forth) wirelessly transmits at least one signal in advance of a predetermined time at which a selected photographic operation according to the signal is to be initiated by a photographic device of the wireless camera system (such as image acquisition by a wireless-enabled camera, a pre-flash operation by such a camera, emission of light by a wireless-enabled flash device, and so forth). Such a method may include receiving a signal wirelessly transmitted by the master device, determining the predetermined time at which the selected photographic operation is to be initiated by the photographic device of the wireless camera system from the received signal, calculating the amount of time to transmit a synchronization signal to the non-wireless photographic device that is perceptible to the non-wireless photographic device (such as a pulsed optical signal), and transmitting the synchronization signal at a time in advance of the predetermined time so that upon receipt of the synchronization signal, a photographic operation of the non-wireless photographic device (such as a flash emission of a non-wireless flash device, and so forth) responsive to the synchronization signal will be initiated at the predetermined time.

The aforementioned illustrative methods may be accomplished using various suitable components and devices as discussed herein. An illustrative example configuration of such a component, constructed in accordance with aspects of the present disclosure, may be in the form of a wireless activation device suitable for use with a non-wireless photographic device (such as a non-wireless flash device) and may include a receiving component, a transmitting component, and functional circuitry. The receiving component of such a wireless activation device may be adapted to receive a radio signal transmitted by a master device of a wireless camera system a predetermined interval of time preceding the performance of a camera operation by a camera of the wireless camera system, whereas the transmitting component may be adapted to transmit an activation signal perceptible to the non-wireless photographic device and that is configured to activate a selected operation of the non-wireless photographic device. The circuitry of such a wireless activation device may be adapted to determine, from the radio signal, the predetermined interval of time, calculate therefrom a time suitable to transmit the activation signal such that the selected operation of the non-wireless photographic device will be synchronized with the performance of the camera operation, and cause the transmitting component to transmit the activation signal at the calculated time.

The concepts, features, methods, and component configurations briefly described above are clarified with reference to the accompanying drawings and detailed description below.

### BRIEF DESCRIPTION OF THE DRAWINGS

FIG. 1 shows a schematic view of an example photographic setup in which a wireless camera system includes a camera and a remote flash device, and in which an illustrative embodiment of a wireless activation device configured accordance with aspects of the present disclosure is used with a non-wireless flash device.

FIG. 2 is a schematic view illustrating the internal layout of various components of the wireless activation device of FIG. 1.

FIG. 3 is a timing chart illustrating an example synchronization sequence utilized in a wireless camera system such as that shown in FIG. 1.

FIG. 4 is a detail of the timing chart of FIG. 3, showing example timing of a sequence of emitting instruction signals transmitted by a camera of a wireless camera system.

FIG. 5 is an example packet data structure of an emitting instruction signal such as used in the timing chart of FIG. 3.

FIG. 6 is a timing chart illustrating an example synchronization sequence utilized in a wireless camera system with several flash units.

### DETAILED DESCRIPTION

The present invention may be described herein in terms of illustrative methods that include various functional steps and processes. Such functional steps and processes may be realized by any number of hardware or software components configured to perform the respective functions and thereby achieve the various results described herein, which may represent various implementations of the present invention. Further, the illustrative methods and implementations thereof are disclosed by way of several examples, such as that may employ photographic equipment such as cameras, flash devices, and so forth, that may be used in a photographic studio setting. However, the invention is not restricted to use with such example settings and equipment, as numerous applications, variations, settings, and use with any image capturing (and accessory) equipment are possible and within the scope of this disclosure.

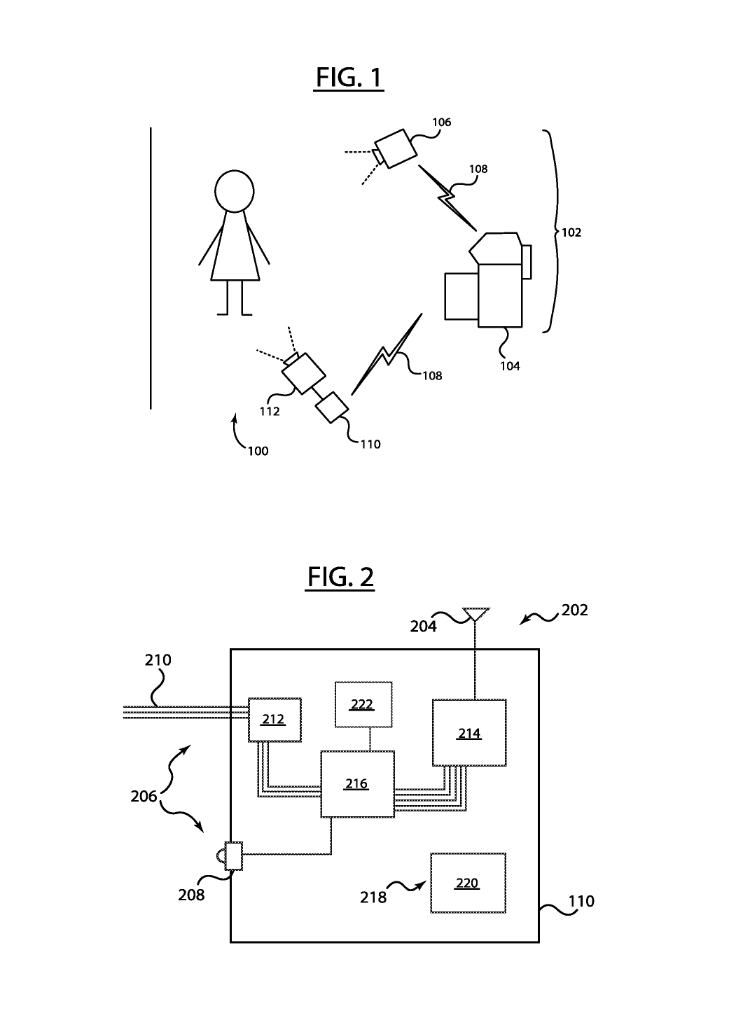

FIG. 1 is a schematic view illustrating an example photographic setup, designated generally as 100, in which a wireless camera system 102 is shown to include a wireless-enabled camera 104 and a wireless-enabled flash device 106 set up remotely from the camera, with which the camera is configured to wireless communicate by means of wireless (i.e. radio) communication signals. More specifically, camera 104 controls the operation of flash device 106 by means of wireless communication signals. As such, the camera 104 (or similar photographic device that provides instruction signals) may be referred to as a master device, whereas the flash device 106 (or similar photographic device that follows the provided instruction signals) may be referred to as a slave device. In some wireless camera systems, for example those that may include multiple cameras, one camera may be designated as a master device to which the other cameras, as well as one or more flash devices of the camera system, are slaved. Some wireless camera systems may include multiple master devices, and/or devices that are master to some and slave to another, and so forth.

The wireless-enabled photographic devices of wireless camera system 102 may be configured as disclosed, for example, in U.S. Patent Application Pub. No. 20100202767 of Shirakawa, the complete disclosure of which is hereby incorporated by reference. For example, wireless-enabled camera 104 and wireless-enabled flash device 106 may each include, in addition to the various optical, mechanical, and electrical components to perform photographic imaging and/or flash emission, a wireless antenna operated by a wireless communication circuit, such that the wireless-enabled photographic devices may communicate via wireless communication signals, generally indicated at 108.

Photographic setup 100 is also shown to include a wireless activation device 110 and a non-wireless flash device 112, which may represent any suitable type of photographic lighting device capable of emitting photographic illumination, such as a studio monolight (for example, a Photogenic PL1250), an electronic flash unit (for example, a Canon Speedlite 430EX), and so forth. As noted above, non-wireless flash devices may be configured for communication with a master photographic device in various ways, the two main ways being via a direct electical connection, such as by means of a cord, cable, hotshoe connection, and so forth, and via optical communications. As such, although wireless activation device 110 is shown to be directly coupled to the flash device 112 via a cord 114, communication between wireless activation device 110 and flash device 112 may not require a direct connection.

As explained in further detail herein, wireless activation device 110 may be configured to receive wireless communications from, and/or otherwise wirelessly communicate with, a wireless-enabled photographic device of a wireless camera system, such as wireless-enabled camera 104 of wireless camera system 102, and thus facilitate integration of a non-wireless photographic device, such as non-wireless flash device 112, with the wireless camera system. In one example, the emission of light from non-wireless flash device 112 may be synchronized with image acquisition by wireless-enabled camera 104. In another example, wireless activation device 110 may establish a communication link between non-wireless flash device 112 and wireless-enabled camera 104, such that the wireless-enabled camera 104 transmits wireless communications to the wireless activation device 110 (which, in turn, may be transmitted to the non-wireless flash device 112) as if the wireless activation device 110 was a slave device, such as a wireless-enabled flash device, of the wireless camera system 102.

FIG. 2 schematically indicates an example layout of various structural and functional components of an illustrative embodiment of a wireless activation device, such as wireless activation device 110. The device includes a receiving component 202, in the form of antenna element 204, which is adapted to receive radio signals, such as the wireless communications transmitted by a photographic device of a wireless camera system. The device further includes a transmitting component 206, which is adapted to transmit an activation signal perceptible to a non-wireless photographic device, such as non-wireless flash device 112. The configuration of the transmitting component may be chosen as suitable to the type of communication that the non-wireless photographic device is configured to receive. For the sake of illustration, wireless activation device 110 is shown in FIG. 2 to be equipped with two transmission means: optical, via an optical emitter shown as an LED 208, and electrical, via signal lines 210 (which may, in turn, transmit signals over a cord or cable, such as indicated in FIG. 1, or direct connection such as a hotshoe connector, and so forth, to the non-wireless photographic device). Signal lines 210 are shown to be connected to a signaling circuitry 212, which may be in the form of a single transistor, such as to allow a voltage present on one or more of the signal lines to be pulled to ground when activated, or may be more elaborate, such as to employ electrical signal configuration techniques known in the art. Somewhat similarly, a radio circuitry 214 connected to antenna element is adapted to read or otherwise interpet received radio signals. Examples of appropriate construction, selection, and arrangement of radio circuitry 214 are disclosed in Applicant's co-pending U.S. Patent Application Pub. Nos. US2009012975, US20100209089, and so forth. Radio circuitry may optionally include various filtering, electrostatic discharge, and/or other components as suitable. In some embodiments, antenna element 204 and/or radio circuitry 214 may be adapted to facilitate transmission of radio signals as well as reception thereof.

The example embodiment of wireless activation device 110 is also shown, in FIG. 2, to include processing means 216 adapted to carry out various processes, calculations, timing, and data manipulations, and issue various instructions, as necessary to achieve the functions described herein. For example, processing means 208 includes a clock source, such as an crystal clocking oscillator or otherwise, either internal to a microprocessor of the processing means, or external to feed a signal thereto, and so forth. A suitable processing means may be a processor such as a Microchip PIC845K20, available commercially from Microchip, Inc. Processing means 208 may optionally include other components and/or modules, multiple iterations thereof, and so forth, and may be connected electrically via wires and/or a printed circuit board, as known in the art, to the receiving component 202 (such as via radio circuitry 214).

The wireless activation device may further include a power source 218, such as an internal power source in the form of a battery 220, or may be externally powered, such as a conventional AC power cord, a USB cable, and so forth. Optionally, the wireless activation device may further include, or be configured to couple with, one or more memory components 222 configured to store data such as programming instructions, operational data, and so forth, such as an internal memory incorporated within or in communication with processing means 216, removable storage media, and so forth. Wireless activation device 110 is shown to commonly house all of the aforementioned components in a single, battery-powered unit, but the various functional components may, in other embodiments, be configured as desired to achieve the functionality of the device as described herein.

In a first illustrative example of using a wireless activation device, such as wireless activation device 110, with a wireless camera system, such as wireless camera system 102, a receiving component of the wireless activation device may begin receiving radio signals, such as those transmitted by wireless-enabled camera 104. One of the signals may be an emission instruction signal or other type of flash instruction transmitted by the camera 104 in advance of performing an image acquisition operation or a pre-flash operation, which includes timing information for the performance of the operation, such as the time interval following the signal after which the operation will occur. The processing means of the wireless activation device may recognize the received signal as an emission instruction signal, read the timing information for the camera operation in the signal, and calculate therefrom the correct timing to prompt the transmitting component to emit an activation signal perceptible to the non-wireless flash device, in turn causing the non-wireless flash device to carry out a desired operation, such as a flash emission, coincident with the camera operation.

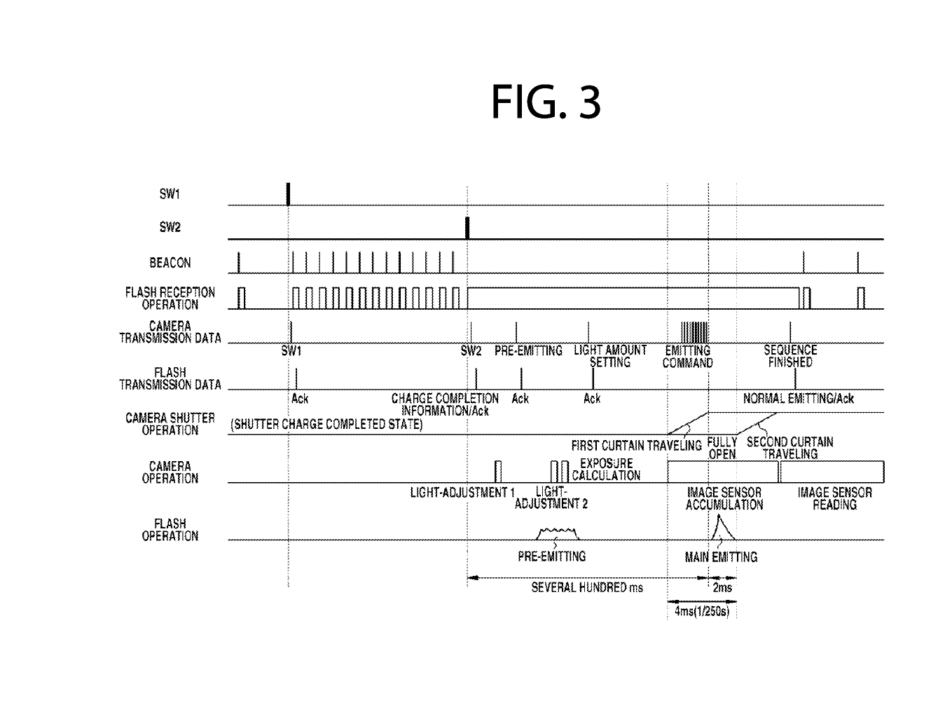

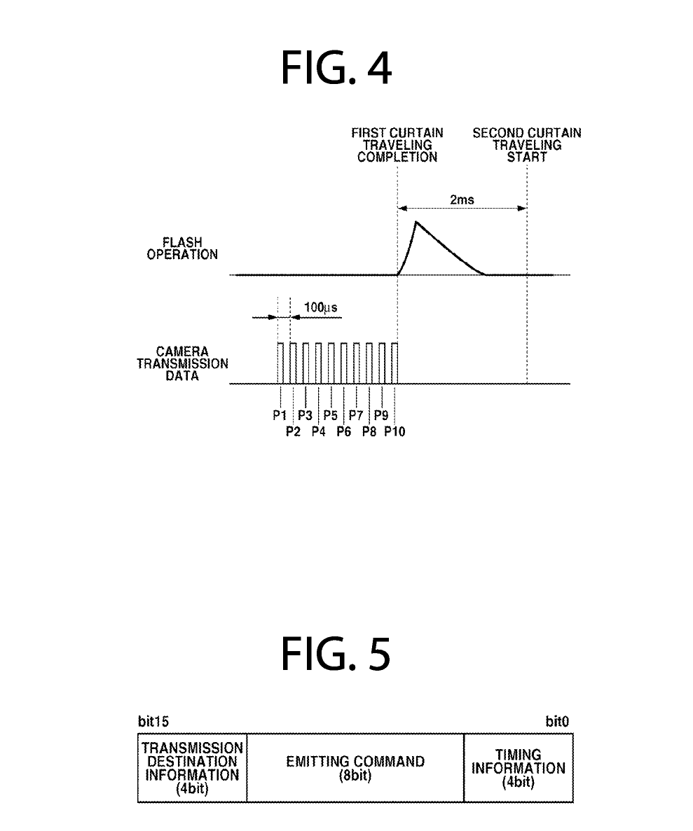

U.S. Patent Application Pub. No. 20100202767 of Shirakawa discloses an example of a wireless camera system in which a wireless-enabled camera issues a sequence of wireless emitting instruction signals in advance of opening its shutter for image acquisition. FIG. 3 shows an example timing chart showing various wireless communications and photographic operations that may occur in such a wireless camera system. On the “camera transmission data” line of the timing chart, a sequence of ten emitting instruction signals (captioned as “emitting commands”) is shown to be wirelessly transmitted by the camera as the first curtain of the camera shutter travels to an open state. FIG. 4 shows a detail of this chart, illustrating in greater detail an example of the timing of the emitting instruction signal sequence P1, P2, . . . , P10, and FIG. 5 shows an example packet data structure of a single emitting instruction signal. As explained in the Shirakawa disclosure, the timing information of each emitting instruction signal may indicate the time until image acquisition by the camera will occur, and thus the timing information of each emitting instruction signal will be different depending on its place in the sequence. For example, if the emitting instruction signals are transmitted every 100 microseconds, the timing information that represents the time until image acquisition will occur in emitting instruction signals in the sequence will decrease incrementally by 100 microseconds as the sequence proceeds from P1 to P10. Such an emitting instruction signal may thus be recognized as such, when received by the receiving component of a wireless activation device, by the emitting command data and/or the timing information data in the packet comprising the emitting instruction signal. In such an example, once an emitting instruction signal is received and identified as such, the processing means of the wireless activation device may be configured to simply ignore subsequent emitting instruction signals in the sequence, or indeed any other signals relating to the same photographic operation.

Of course, the example wireless camera system discussed above employs one example technique of transmitting signals—specifically, a sequence of emission instruction signals that each include timing information as part of the signal—prior to a photographic operation. Other wireless camera systems may not include a sequence of redundant emission instruction signals, and may instead transmit a single emission instruction signal that includes timing information, and still others may transmit one or more emission instruction signals that do not include timing information.

Moreover, an emission instruction signal is one example of a signal that may be transmitted by a master device of a wireless camera system that characteristically precedes the performance of a selected photographic operation by a predetermined time interval. Some wireless camera systems may employ other wireless signals that characteristically precede a selected operation, which may be recognized as such in a variety of manners, such as by observing the wireless communications that are transmitted prior to a variety of photographic operations and recording such communications in a memory accessible, for example, to a wireless activation device. Thus, when a wireless activation device receives such a signal, the predetermined time interval may be determined by recognizing the signal, and use an observed time interval from a prior operation of the camera system. Such signals, and corresponding time intervals, may be characteristic of and/or proprietary to certain camera systems and may thus differ among systems or manufacturers, and as such may be preprogrammed into memory to be retrieved according to the wireless camera system in use, and so forth.

A second illustrative example of using a wireless activation device, such as wireless activation device 110, with a wireless camera system, involves the use of such a different type of wireless signal. In the second illustrative example, a wireless signal indicating that a camera shutter button has been half- or fully-pressed by a user operating the camera may be transmitted by the camera, and received by the wireless activation device 110. Such a signal may characteristically precede a subsequent flash instruction for a flash device to emit a pre-flash emission, and/or the performance of a light measurement operation by the camera, by a predetermined amount of time.

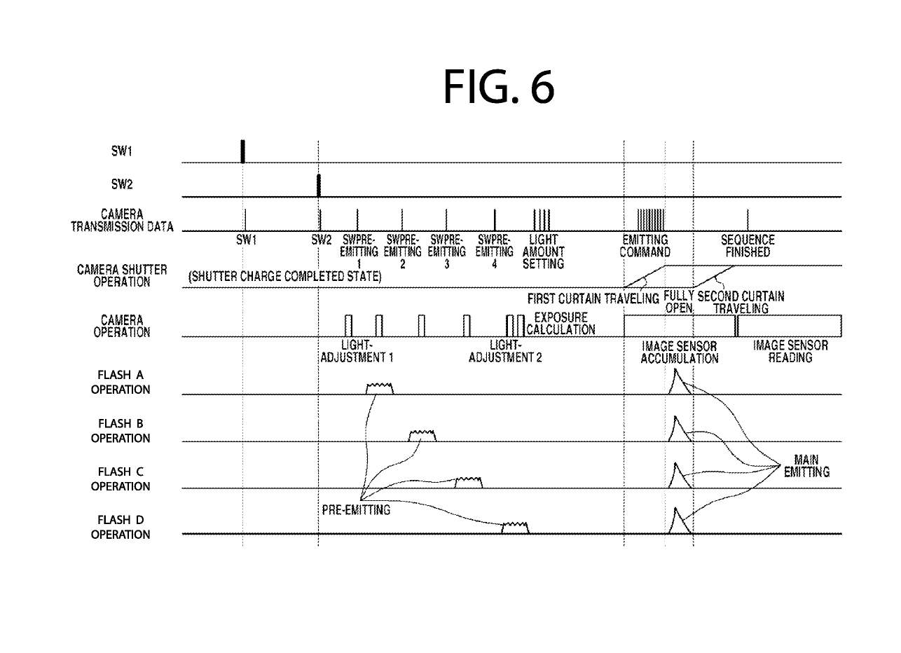

FIG. 6 shows an example timing chart showing various wireless communications and photographic operations that may occur in a wireless camera system that employs a wireless-enabled camera and four wireless-enabled flash devices. As illustrated on the “camera transmission data” line of the chart, the SW2 signal, which may correspond to a full-press of the shutter button of the camera, may precede the subsequent transmission of four pre-emitting commands (captioned as SWPRE-EMITTING 1-4). The “camera operation” line and the four “flash operation” lines of the timing chart indicate responsive photographic operations of the four flashes (i.e., pre-flash emissions) and the camera (i.e., pre-flash measurements) that follow the pre-emitting commands.

As noted above, the delay between transmission of the SW2 signal and the transmission of the subsequent pre-emitting commands may be a known characteristic of the camera system in use, or may be recorded from a previously observed photographic operation thereof. As such, upon the receipt of a SW2 signal by a wireless activation device, the processing means thereof may recognize the received signal as such, and determine the predetermined time interval until the performance of a subsequent camera or flash operation, even though the SW2 signal itself may not contain any timing information, such by using an observed time interval. The observed time interval may be one that was used in a prior operation of the camera system that the wireless activation device observed and recorded, or that has been preprogrammed into memory accessible to the wireless activation device, and so forth. As in the first illustrative example, the processing means of the wireless activation device may then calculate the correct timing to prompt the transmitting component to emit an activation signal perceptible to a non-wireless flash device, in turn causing the non-wireless flash device to carry out a desired operation, such as a pre-flash emission, coincident with the camera or flash operation.

In one or both of the illustrative examples discussed above, the time interval between the receipt of a signal from a photographic device and the performance of a corresponding, subsequent photographic operation may exceed the amount of time needed, such as by the wireless activation device, for formatting and transmitting an emission synchronization signal to a non-wireless flash device, and any time required by the non-wireless flash device to prepare for the emission. In one non-limiting example, if the non-wireless flash device is charged and prepared to emit a pre-flash (such as following a prior signal from the wireless activation device), the wireless activation device may only need a short amount of time, such as 1 millisecond, to produce and transmit an appropriate signal for the non-wireless flash device, such as a pulsed light signal. In other examples, such as that may involve a flash instruction such as an emission instruction signal, the emission instruction signal may precede image acquisition by the camera by 1 millisecond, in which case the wireless activation device may initiate the production of a corresponding pulsed light signal for the non-wireless flash device upon (or even while) receiving the emission instruction signal. However, in other examples, such as that may involve a SW2 or similar wireless signal, such a signal may precede the subsequent camera operation by an interval greater than 1 millisecond, such as several milliseconds, or even several tens or hundreds of milliseconds. Accordingly, once the time interval is determined from such a signal, the wireless activation device may allow an appropriate portion of the time interval to elapse before transmitting the emission synchronization signal to the non-wireless flash device, to synchronize the emission by the flash device with the camera operation.

Similarly, processing means of a wireless activation device may calculate the proper portion of the time interval to elapse before transmitting a synchronization signal to the non-wireless flash device for any manner of transmitting the synchronization signal, and based on any received wireless signal that may be recognized as preceding a selected photographic operation by a predetermined amount of time. Such signals may include one of those indicated on the “camera transmission data” lines of the example timing charts shown in FIGS. 3 and 6 (e.g., SW1, SW2, PRE-EMITTING, SWPRE-EMITTING 1-4, LIGHT AMOUNT SETTING, EMITTING COMMANDS such as P1, P2, . . . , P10, etc.), those indicated on the “flash transmission data” lines of the example timing charts (e.g., acknowledgment signals designated as “Ack,” etc.), other commands transmitted in the wireless camera system, such as beacon signals, and so forth, and any combination thereof.

Although not required to all embodiments, some methods of synchronizing an operation of a non-wireless flash device with a selected photographic operation by a wireless-enabled photographic device that is part of a wireless camera system may include wirelessly transmitting a signal to a wireless-enabled photographic device (such as a camera or other master device) of the wireless camera system, which is configured to be interpreted by the photographic device as if it was sent by a wireless-enabled flash device (or other slave device) of the wireless camera system. For example, with reference to the example wireless camera system 102 illustrated in FIG. 1, wireless activation device 110 may be configured to instruct wireless-emabled camera 104 that it is a participant of wireless camera system 102, such as by identifying itself to the camera as another wireless-enabled flash device, such as in addition to wireless-enabled flash device 106, that may be used by the camera during image acquisition and other operations. Applicant's co-pending U.S. Patent Application Pub. No. US20100008658, for example, describes the use of pseudo communications provided by a communication device to a camera system participant (such as a flash device or camera), that are interpreted by the camera system participant as if the pseudo communications were actual communications that originated from another camera system participant. In this or another suitable manner, wireless activation device 110 may establish a communication link with camera 104, for example so that the camera thereafter communicates with the wireless activation device as if it was a slave device of wireless camera system 102. Similarly, some methods may include including establishing a communication link with the photographic device that transmits the received signal such that the device thereafter wirelessly communicates via the communication link as it if was communicating with another wireless-enabled photographic device of the wireless camera system.

Optionally, a non-wireless flash device may be instructed, such as by means of a wireless activation device, to set a light emission output level to a desired level, such as a level that would characteristically be emitted by a wireless-enabled flash device of the wireless camera system with which the non-wireless flash device is being used. Such a light emission output level may be encoded in a flash instruction received from a photographic device of the wireless camera system, such as an emission instruction signal, and/or another signal such as a LIGHT AMOUNT SETTING signal (such as indicated in FIGS. 3 and 6), a PRE-EMITTING or SWPRE-EMITTING signal (id.), and so forth. Alternatively, a wireless activation device may calculate a different light emission output level for the non-wireless flash device that is based on such a signal. The light emission output level information may be transmitted to the non-wireless flash device together with an emission synchronization signal, or separately.

In the foregoing disclosure, the present invention has been described with reference to specific illustrative embodiments, methods, processes, and other examples, and selected variants thereof. It will be apparent to those skilled in the art that various modifications and changes may be made, however, without departing from the scope of the present invention as set forth in the claims. The specification and drawings are provided for illustrative purposes, rather than to restrict or limit any aspect of the scope of the disclosure. The present invention is intended to embrace all such alternatives, modifications and variances that fall within the scope of the appended claims.

For example, the steps, actions, or events recited in any of the methods or processes disclosed and/or claimed herein may be executed in any order and may not be limited to the specific order presented. Additionally, components and/or elements presented and/or claimed in any apparatus, device, component herein may be assembled or otherwise operationally configured in a variety of permutations and accordingly may not be limited to the specific configuration(s) presented.

Further, benefits, other advantages, and solutions to problems or challenges may be described herein with regard to particular embodiments, however, any such benefit, advantage, solution, or any element that may enhance or cause any particular benefit, advantage, or solution to occur are not to be construed as critical, required, or essential features or components of the invention, nor should the claims be construed as exclusively addressing such benefits, advantages, or solutions.

I claim:

1. A method of synchronizing the emission of light from a non-wireless flash device with the performance of a selected photographic operation by a photographic device that is part of a wireless camera system, the method comprising:
receiving one or more signals wirelessly transmitted by a photographic device of the wireless camera system;
identifying at least one received signal as a signal that characteristically precedes the performance of the selected photographic operation by a predetermined time interval;
determining, from the identified signal, the predetermined time interval; and
transmitting an emission synchronization signal perceptible to the non-wireless flash device so that emission of light from the non-wireless flash device responsive to the emission synchronization signal is synchronized with the performance of the selected photographic operation.

2. The method of claim 1, wherein identifying at least one received signal includes identifying the signal as an emission instruction signal.

3. The method of claim 2, wherein the selected photographic operation is one or more of image acquisition by a wireless-enabled camera and a pre-flash operation by a wireless-enabled camera.

4. The method of claim 2, wherein the predetermined time interval is included in the emission instruction signal as timing information that indicates timing for a flash device to emit light at a time coincident with the performance of the photographic operation by the photographic device, and wherein determining the predetermined time interval includes reading the timing information.

5. The method of claim 4, wherein the identified emission instruction signal is one of a sequence of emission instruction signals transmitted by the photographic device;
wherein each of the sequence of emission instruction signals includes different timing information depending on its place in the sequence; and
wherein identifying at least one received signal further includes subsequently ignoring other emission instruction signals in the sequence of emission instruction signals.

6. The method of claim 1, wherein determining the predetermined time interval includes using an observed time interval from a prior operation of the camera system in which a prior iteration of the identified signal preceded the subsequent performance of the corresponding selected photographic operation by the photographic device of the wireless camera system.

7. The method of claim 1, wherein the photographic device that transmits the received signal is the photographic device of the wireless camera system that will perform the selected photographic operation.

8. The method of claim 1, further including wirelessly transmitting a signal back to the photographic device that transmits the received signal as if it was sent from another wireless-enabled photographic device of the wireless camera system.

9. The method of claim 1, further including establishing a communication link with the photographic device that transmits the received signal such that the device thereafter wirelessly communicates via the communication link as it if was communicating with another wireless-enabled photographic device of the wireless camera system.

10. The method of claim 1, wherein transmitting an emission synchronization signal to the non-wireless flash device includes one or more of sending the emission synchronization signal optically and via an electrical connection.

11. The method of claim 10, wherein transmitting an emission synchronization signal to the non-wireless flash device includes initiating the transmission at a time sufficiently in advance of the performance of the photographic operation so as to complete transmission and allow the non-wireless flash device any necessary time to emit light synchronized with performance of the photographic operation.

12. The method of claim 11, further including, prior to transmitting the emission synchronization signal to the non-wireless flash device, calculating the time at which the transmission should be initiated.

13. The method of claim 11, further including, prior to transmitting the emission synchronization signal to the non-wireless flash device, allowing at least a portion of the predetermined time interval to elapse.

14. The method of claim 1, wherein one or more of the received signals includes an emission output level, and wherein transmitting an emission synchronization signal perceptible to the non-wireless flash device includes transmitting emission output level information for the non-wireless flash device that either corresponds to or is based on the emission output level in the one or more received signals.

15. The method of claim 1, further including, prior to transmitting the emission synchronization signal to the non-wireless flash device, allowing at least a portion of the predetermined time interval to elapse.

16. A method of integrating a non-wireless photographic device into a wireless camera system in which a master device of the wireless camera system wirelessly transmits at least one signal in advance of a predetermined time at which a selected photographic operation according to the signal is to be initiated by a photographic device of the wireless camera system, the method comprising:
receiving a signal wirelessly transmitted by the master device;
determining, from the received signal, the predetermined time at which the selected photographic operation is to be initiated by the photographic device of the wireless camera system;
calculating an amount of time to transmit a synchronization signal to the non-wireless photographic device that is perceptible to the non-wireless photographic device; and
transmitting the synchronization signal at a time in advance of the predetermined time so that upon receipt of the synchronization signal, a photographic operation of the non-wireless photographic device responsive to the synchronization signal will be initiated at the predetermined time.

17. The method of claim 16, wherein the synchronization signal includes at least one setting level for the photographic operation of the non-wireless photographic device.

18. The method of claim 16, further including, after determining the predetermined time at which the selected photographic operation is to be initiated, ignoring any other signals transmitted by the master device relating to the same selected photographic operation.

19. A wireless activation device for use with a non-wireless photographic device, the wireless activation device comprising:
a receiving component adapted to receive a radio signal that is transmitted by a master device of a wireless camera system a predetermined interval of time preceding the performance of a camera operation by a camera of the wireless camera system;
a transmitting component adapted to transmit an activation signal that is perceptible to the non-wireless photographic device and that is configured to activate a selected operation of the non-wireless photographic device; and
circuitry adapted to determine, from the radio signal, the predetermined interval of time, calculate therefrom a time suitable to transmit the activation signal such that the selected operation of the non-wireless photographic device will be synchronized with the performance of the camera operation, and cause the transmitting component to transmit the activation signal at the calculated time.

20. The wireless activation device of claim 19, wherein the non-wireless photographic device includes a non-wireless flash device.
